(19) United States
(12) Patent Application Publication
(10) Pub. No.: US 2026/0175126 A1
(43) Pub. Date: Jun. 25, 2026

(54) SYSTEMS AND METHODS FOR INTELLIGENT GENERATION OF NAVIGATION KEYPOINTS

(71) Applicants: ADVANCED MICRO DEVICES, INC., Santa Clara, CA (US); ATI TECHNOLOGIES ULC, Markham (CA)

(72) Inventors: Ian Charles Colbert, San Diego, CA (US); Mehdi Saeedi, Thornhill (CA); Alexander Walter Cann, Markham (CA)

(21) Appl. No.: 18/987,942

(22) Filed: Dec. 19, 2024

(51) Int. Cl. A63F 13/537

(52) U.S. Cl. CPC A63F 13/537

(57) ABSTRACT

At least one memory is configured to store information representing a distribution of probabilities that a first agent passes through locations in an environment as the first agent moves from a first location to a second location. At least one processor is configured to select a first keypoint in an environment based on the distribution of probabilities and select one or more second keypoints in the environment based on the distribution of probabilities, the first keypoint, and any previously selected keypoints. The at least one processor is also configured to instruct a second agent to move from the first location to the second location along a trajectory that includes the first keypoint and the second keypoint(s). The at least one processor can implement autoregressive generator circuitry and keypoint scheduler circuitry.

### BACKGROUND

In video games and other interactive simulations, non-human agents are often required to navigate through worlds shared with humans or human-controlled entities. In virtual worlds, non-human agents such as non-player characters (NPCs) share the virtual world with characters controlled by human players. In the real world, robots or humanoid devices are required to navigate environments designed for ease of human mobility.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a processing system configured to generate navigation keypoints for non-human agents according to some embodiments.

FIG. 2 illustrates generation of keypoints based on a probability distribution that indicates probabilities that a non-human agent passes locations in an environment according to some embodiments.

FIG. 3 illustrates keypoints that are selected by an autoregressive generator based on a binning criterion that spreads the keypoints along the trajectory of the non-human agent according to some embodiments.

FIG. 4 illustrates a method of selecting keypoints for motion of a non-human agent based on a probability distribution and previously selected keypoints between a source location and a destination location according to some embodiments.

### DETAILED DESCRIPTION

In a virtual world in a video game or other interactive simulation, shortest path search algorithms or other heuristics can be used to identify a trajectory of a non-human agent between two locations along an ideal path between a starting location and a destination. However, humans do not always follow the shortest path and consequently non-human agents that navigate using the shortest path criteria (or other heuristics) may behave differently than humans. Additionally, in some cases the shortest path may not be directly computable, such as during a puzzle, or in a dynamic environment. Behavior trees can provide rules that reflect human choices. For example, in a virtual world, a behavior tree may be used to decide whether an NPC moves towards or runs away from a player character that approaches NPC. However, behavior trees have a limited decision-making capability in both scope and adaptability and require significant engineering resources to develop. Deep neural networks (DNNs) can be trained to emulate the behavior of a human in a variety of contexts. However, very large DNN models are required to emulate human behavior and training the DNN model requires a significant investment of resources. This problem is exacerbated for DNN models of non-human agents that navigate large and complex environments. Thus, constraints including limitations of the model, time, compute resources, and the environment or context can prevent non-human agents from exhibiting human-like behavior even when performing a simple task such as navigation.

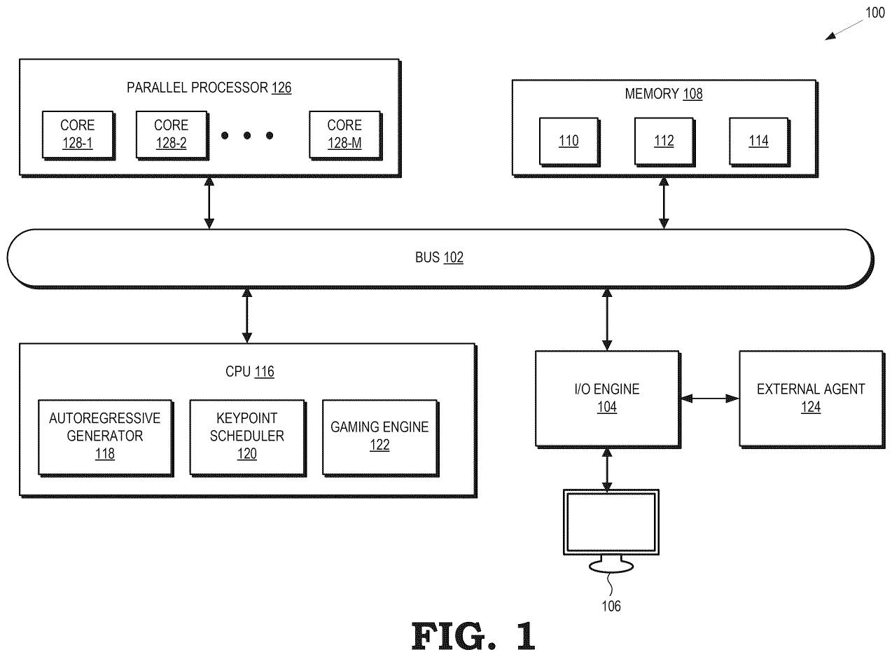

FIGS. 1-4 illustrate embodiments and implementations involving an autoregressive generator that reduces the resources needed to endow non-human agents with human-like navigation abilities by identifying keypoints along a trajectory between a first location and a second location. The autoregressive generator selects a first keypoint in an environment based on a distribution of probabilities that the non-human agent passes through locations in the environment as the non-human agent moves from the first location to the second location. In some embodiments, the probability distribution is determined based on a set of navigation trajectories determined by a navigation policy. In response to selecting the first keypoint, the autoregressive generator selects a second keypoint in the environment based on the probability distribution and the first keypoint. The autoregressive generator then iteratively selects at least one third keypoint in the environment based on the probability distribution and the previously determined keypoints. The keypoints can be determined based on an optimization criterion that guides selection of a coordinate that has the highest likelihood of being a part of the trajectory given that the trajectory includes the previously determined keypoints. In some embodiments, coordinates are binned into regions having a predetermined dimension and the autoregressive generator is constrained to select no more than one keypoint within each bin. The autoregressive generator can be implemented as an empirical probability estimator, a deep neural network, or some other type of estimator.

The autoregressive generator does not necessarily select the keypoints in the order that they would be passed by a non-human agent moving along the trajectory. A keypoint scheduler, or other circuitry that implements an ordering function or algorithm, is therefore used to order the keypoints selected by the autoregressive generator. The keypoint scheduler can be implemented separately from the autoregressive generator or as an integrated part of the autoregressive generator. Some embodiments of the autoregressive generator tag the keypoints with an estimated time that the non-human agent arrives at the corresponding keypoint. The keypoint scheduler can use the tags to establish a temporal order for the keypoints along the trajectory of the non-human agent. If the same keypoint is associated with different arrival times, the keypoint scheduler can order the keypoints by an average time at which the non-human agent arrives. Some embodiments of the autoregressive generator include the time dimension in the coordinate system of the keypoints so that the autoregressive generator can account for time in the likelihood estimate. In that case, some embodiments of the keypoint scheduler would still reorder the keypoints. The ordered list of keypoints is provided to control movement of the non-human agent according to the specified order. In some embodiments, the autoregressive generator is implemented as part of a gaming engine and the keypoints represent locations in a virtual world implemented in a game. In other embodiments, the autoregressive generator is implemented as part of the control system for a robot or humanoid device. The keypoints in that case represent locations along a trajectory in an environment that may be shared with humans.

FIG. 1 illustrates an apparatus including a processing system 100 configured to generate navigation keypoints for non-human agents according to some embodiments. The processing system 100 includes a bus 102 implemented with circuitry that supports communication between entities implemented in the processing system 100. Some implementations of the processing system 100 include other buses, bridges, switches, routers, and the like, which are not shown in FIG. 1 in the interest of clarity. An input/output (I/O) engine 104 is implemented with circuitry that handles input or output operations associated with display 106, as well as other elements of the processing system 100 such as keyboards, mice, printers, external devices, external disks, and the like. The I/O engine 104 is coupled to the bus 102 so that the I/O engine 104 can communicate with other entities in the processing system 100 by exchanging signals over the bus 102.

Processing system 100 also includes or has access to a memory 108 or other storage component implemented using a non-transitory computer-readable medium, for example, a dynamic random-access memory (DRAM). However, in implementations, the memory 108 is implemented using other types of memory including, for example, static random-access memory (SRAM), nonvolatile RAM, and the like. According to implementations, the memory 108 includes an external memory implemented external to the processing units implemented in the processing system 100. Some embodiments of the memory 108 store information representing instructions such as program code 110 for one or more applications (e.g., graphics applications, compute applications, machine-learning applications), data 112 that is consumed by the program code 110, and results 114 produced by executing the program code 110.

The processing system 100 includes a central processing unit (CPU) 116 that is connected to the bus 102 to communicate with other entities in the processing system 100, such as the memory 108. The CPU 116 implements circuitry such as a plurality of processor cores (not shown in FIG. 1 in the interest of clarity) that execute instructions concurrently or in parallel. In some implementations, one or more of the processor cores operate as SIMD units that perform the same operation on different data sets. The CPU 116 is configured to execute instructions such as the program code 110 for one or more applications (e.g., graphics applications, compute applications, machine-learning applications), which is stored in the memory 108. The CPU 116 can consume data 112 and store information in the memory 108 such as the results 114 of the executed instructions.

In the illustrated embodiment, an autoregressive generator 118 is implemented in the CPU 116 using circuitry configured to generate keypoints along a trajectory between a starting location and a destination location in an environment. The trajectory can represent a path in a 2D space (e.g., movement of a physical non-human agent across a floor) or a 3D space (e.g., movement of a robotic “hand” or “arm” that performs pick-and-place operations). Thus, the term “navigation” refers herein to selecting, defining, specifying, or determining a path in one or more spatial dimensions, as well as controlling, guiding, steering, or moving a physical or virtual entity along the path in one or more spatial dimensions. The environment can be a virtual environment such as a gaming world or a physical environment in the real world. If the environment is a virtual environment, a virtual non-human agent such as a non-player character (NPC) in a game navigates through the virtual environment using the trajectory between the starting and destination locations indicated by the keypoints. If the environment is a physical environment, a physical non-human agent such as a robot or humanoid device navigates through the physical environment using the trajectory between the starting and destination locations. In that case, the physical non-human agent can share the physical environment with one or humans.

The autoregressive generator 118 is configured to select keypoints along a trajectory in an environment based on the probability that an instructive navigation agent passes through locations in the environment as the instructive navigation agent moves from the starting location to the destination location. The agent that acts as the instructive navigation agent can be different from the non-human agent that navigates according to the keypoints determined by the autoregressive generator 118, the same as the non-human agent, or a combination thereof. For example, an initial trajectory for the non-human agent can be generated using a different instructive navigation agent during one or more iterations and then the trajectory variance of the non-human agent can be reduced by pushing the non-human agent to follow its own expected path during one or more subsequent iterations. In some embodiments, the instructive navigation agent is a human agent that is tracked as they move from the starting location to the destination location. The tracked movements of the human agent are used to determine the probabilities of passing the locations in the environment, e.g., by combining tracked movements of the human agent moving from the starting location to the destination location multiple times, by combining tracked movements of multiple human agents moving from the starting location to the destination location, or combination thereof. In some embodiments, the probability distribution is determined based on a navigation policy for a non-human instructive navigation agent. For example, the CPU 116 (or other processing unit within the processing system 100 or external to the processing system 100) can generate a set of navigation trajectories between the starting and destination locations. The probability distribution can then be determined based on the set of navigation trajectories.

The autoregressive generator 118 selects the keypoints using a recursive algorithm so that each keypoint is selected based in part on the keypoints selected in previous iterations of the recursive algorithm. In some embodiments, the autoregressive generator 118 selects one keypoint per iteration and each keypoint is selected based on the distribution of probabilities and the keypoints that were selected in previous iterations of the recursive algorithm. As discussed herein, the autoregressive generator 118 does not necessarily select the keypoints in the order they will be visited by the non-human agent.

In the illustrated embodiment, a keypoint scheduler 120 is implemented in the CPU 116 using circuitry configured to specify an order for the selected keypoints that indicates the order that the keypoints are passed (or visited or traversed) by the non-human agent as it moves along the trajectory from the starting location to the destination location. Some embodiments of the autoregressive generator 118 tag the selected keypoints with estimated arrival times for the non-human agent at the corresponding keypoints. The keypoint scheduler 120 is configured to order the selected keypoints based on the estimated arrival times indicated in the tags associated with the selected keypoints. Some embodiments of the autoregressive generator 118 include the time dimension as part of the coordinate system used by the recursive algorithm that selects the keypoints. However, incorporating the time dimension does not necessarily imply that the keypoints will be generated by the autoregressive generator 118 in the order they are visited by the non-human agent. Thus, the keypoint scheduler 120 can still be used to reorder the keypoints generated by these embodiments of the autoregressive generator 118. Although the autoregressive generator 118 and the keypoint scheduler 120 are depicted as separate entities in FIG. 1, some embodiments of the autoregressive generator 118 incorporate a keypoint scheduler 120.

An ordered list of the keypoints selected by the autoregressive generator 118 and ordered by the keypoint scheduler 120 is provided to the non-human agent or a control entity that controls movement of the non-human agent based on the ordered list. In the illustrated embodiment, the ordered list can be provided to a gaming engine 122 that uses the ordered list to control the movement of a virtual non-human agent (such as an NPC) within the virtual environment of a game. In some embodiments, the ordered list is provided to an external agent 124 via the bus 102 and the I/O engine 104. For example, the external agent 124 can be implemented as circuitry in (or in control of) a robot or humanoid device that navigates a physical environment such as a warehouse. In response to receiving the ordered list, the gaming engine 122 or external agent 124 can instruct the non-human agent to move from the starting location to the destination location via the keypoints in the order indicated by the ordered list. The gaming engine 122 or external agent 124 can determine trajectories between the starting location, the keypoints, and the destination location using algorithms such as a shortest path algorithm, behavior trees, or a trained neural network.

Some embodiments of the processing system 100 include a parallel processor 126. The parallel processor 126 can include, for example, a GPU, a general-purpose GPU (GPGPU), a neural processing unit (NPU), an intelligence processing unit (IPU) or other vector processor or type of parallel processor. The parallel processor 126 includes circuitry to implement one or more processor cores 128-1 . . . . M that each operate as a compute unit configured to perform one or more operations based on one or more instructions received by the parallel processor 126. Although three processor cores 128 are shown in FIG. 1, more or fewer processor cores 128 can be implemented in other embodiments of the parallel processor 126. The compute units in the processor cores 128 are implemented as circuitry for one or more single-instruction, multiple data (SIMD) units that perform the same operation on different data sets to produce one or more results. Although the autoregressive generator 118, the keypoint scheduler 120, and the gaming engine 122 are implemented by the CPU 116 in FIG. 1, some embodiments of the parallel processor 126 can include circuitry that implements some or all the functionality of the autoregressive generator 118, the keypoint scheduler 120, or the gaming engine 122.

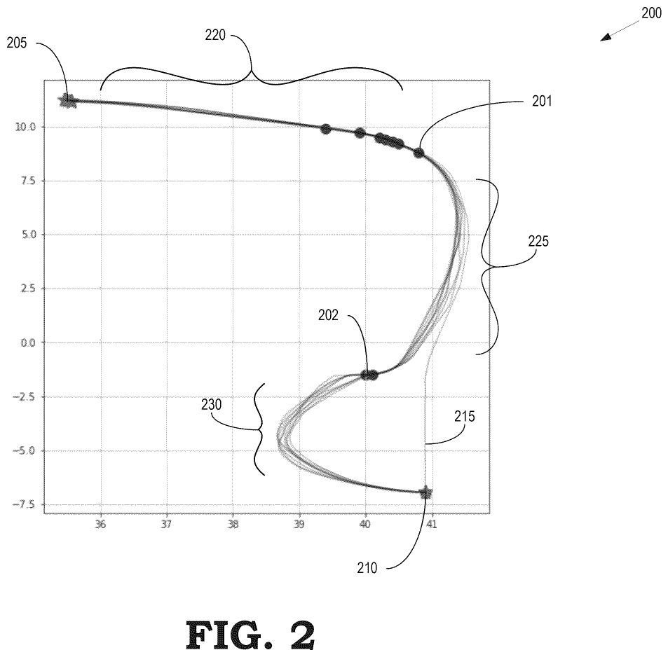

FIG. 2 illustrates generation of keypoints based on a probability distribution that indicates probabilities that a non-human agent passes locations in an environment 200 according to some embodiments. An autoregressive generator such as the autoregressive generator 118 shown in FIG. 1 derives a set of keypoints 201, 202 (only two of the derived keypoints are indicated by reference numerals in the interest of clarity) along a trajectory from a starting or source location 205 to an ending or destination location 210. In the illustrated embodiment, a Cartesian coordinate x is sampled from a set of Cartesian coordinates X based on a navigation policy π*, which may be an optimal navigation policy π*.

The goal of the navigation policy π* is to guide the non-human agent from the source location 205 to the destination location 210 according to a metric such as human-likeness, shortest path, and the like. The autoregressive generator proposes a Cartesian coordinate \hat{x} that a non-human agent navigating according to the navigation policy π* is likely to have passed while navigating from the source location 205 to the destination location 210. Thus, instead of heuristically selecting coordinates along an idealized navigation trajectory (or ideal path), the autoregressive generator selects coordinates in space according to the likelihood that an ideal agent passes through the selected coordinates or keypoints while navigating according to the navigation policy π*. The navigation behavior of the “ideal agent” does not necessarily correspond to the navigation trajectory of an optimal agent. In some cases, the generated keypoints 201, 202 correspond to a sub-optimal navigation path in terms of some optimization criteria such as a shortest path distance.

In the illustrated embodiment, a set of trajectories 215 (only one indicated by a reference numeral in the interest of clarity) are generated based on the navigation policy π*. The trajectories 215 are constrained to begin at the source location 205 and end at the destination location 210. The trajectories 215 are tightly grouped and have a higher density at some coordinates such as coordinates in the region 220, which indicates that there is a high probability that a non-human agent passes (or visits or traverses) these locations as it moves between the source location 205 and the destination location 210. The high probabilities in the region 220 are reflected in the probability distribution derived from the set of trajectories 215. The trajectories 215 are more widely distributed and have a lower density in the regions 225, 230, which indicates a relatively lower probability that the non-human agent passes any one of the locations in the regions 225, 230. The lower probabilities in the regions 225, 230 are reflected in the probability distribution derived from the set of trajectories 215.

The autoregressive generator recursively identifies the keypoints 201, 202 based on the probability distribution derived from the set of trajectories 215. Let P_{X}(x; π*) denote the probability that navigation policy π* passes through a location x given that the trajectory begins at location x₀ (such as the source location 205) and ends at location x_{T} (such as the destination location 210). The first or initial keypoint is sampled or selected according to the optimization criteria:

$${\hat{x}}_{0} = {max}_{x} {P}_{X} ( x \vert {x}_{0} , {x}_{T} ; {π}^{*} )$$

Subsequent keypoints are sampled or selected based on the navigation policy π* and the previously selected keypoints. For example, let P_{X}(x|\hat{x}₀, x₀, x_{T}; π*) denote the probability that navigation policy π* passes through a location x given that the trajectory begins at location x₀, passes through the location \hat{x}₀ (which was generated in the previous step), and ends at location x_{T}. The next keypoint is therefore sampled or selected according to the optimization criteria:

$${\hat{x}}_{1} = {max}_{x} {P}_{X} ( x \vert {\hat{x}}_{0} , {x}_{0} , {x}_{T} ; {π}^{*} )$$

This process is iterated using the probability P_{X}(x|\hat{x}₀, x₁, . . . , x₀, x_{T}; π*) to sample or select additional keypoints. For a set of N total generated keypoints, information representing a list

$${\{ {\hat{x}}_{i} \}}_{i = 0}^{N - 1}$$

of the sampled (or selected or generated) keypoints is conveyed to a keypoint scheduler such as the keypoints scheduler 120 shown in FIG. 1.

The number of keypoints 201, 202 selected by the autoregressive generator is a matter of design choice. In some embodiments, generating more keypoints can bias the trajectory of the non-human agent towards an expected path in the set of trajectories 215. A trade-off can exist between these biases and a variance in the behavior of the non-human agent, which is dependent on characteristics of the non-human agent because the trajectory between two consecutive keypoints 201, 202 can be created based upon different algorithms. For example, a shortest path algorithm can be used to generate the trajectory between two consecutive keypoints 201, 202 or a machine learning/artificial intelligence (ML/AI) model can be trained to perform the navigation sub-tasks. Thus, the variance of the long-range navigation trajectory (e.g., between the source location 205 and the destination location 210) depends on the variance of the keypoints 201, 202 selected by the autoregressive generator and the variance of the trajectories generated by the navigation agent for the navigation sub-tasks between consecutive keypoints 201, 202.

In the illustrated embodiment, the autoregressive generator employs a deterministic variant of an empirical probability model, as discussed above. In other embodiments, the autoregressive generator employs variants of this algorithm or other algorithms. For example, the autoregressive generator can be constrained to avoid areas or portions of the environment 200, e.g., by assigning a zero or low probability to these areas or portions of the environment 200. The probability distribution can also be modeled with a neural network. Stochastic variants can also be introduced to sample the keypoints 201, 202 based on the likelihoods rather than selecting the keypoints 201, 202 based on the maximum likelihoods.

The autoregressive generator samples the keypoints 201, 202 based on spatial coordinates and does not account for the time coordinate. Consequently, the keypoints 201, 202 can be sampled out of order, i.e., in an order that does not correspond to the order they are visited by the non-human agent navigating from the source location 205 to the destination location 210. A keypoint scheduler such as the keypoint scheduler 120 shown in FIG. 1 is therefore used to order the keypoints 201, 202 in the order that they are visited by the non-human agent. Some embodiments of the autoregressive generator tag the keypoints 201, 202 with an estimated time that the non-human agent reaches the corresponding keypoint 201, 202, which provides an approximate ordering criterion for the keypoint scheduler. The autoregressive generator can use other tagging mechanisms to indicate the ordering criterion in some embodiments. If tags are provided, the keypoint scheduler generates the ordering based on the tags received from the autoregressive generator. Some embodiments of the keypoint scheduler generate the ordering, at least in part, based on modeling or statistical information generated using machine learning techniques, artificial intelligence, expert guidance, and the like.

The spacing between some of the keypoints 201, 202 shown in FIG. 2 is relatively small and no keypoints are selected in some high probability regions such as the region 220. In some embodiments, the distribution of the keypoints 201, 202 can be modified to smooth the distribution of the keypoints 201, 202 so that they are spread more evenly along the trajectory. Modifying the distribution can include moving the keypoints 201, 202 to new locations, adding keypoints at new locations, or removing one or more or the keypoints 201, 202. For example, a binning criteria can be used to distribute the keypoints 201, 202 more broadly. The binning criteria can include a minimum threshold distance between neighboring keypoints, a maximum density of keypoints, a maximum number of keypoints within a predetermined area, and the like. For another example, candidate keypoints can be weighted by proximity to previously selected keypoints 201, 202 so that candidate keypoints that are closer to the previously selected keypoints 201, 202 are less likely to be chosen and candidate keypoints that are more distant from the previously selected keypoints 201, 202 are more likely to be chosen. In some embodiments, the keypoint scheduler applies the binning or weighting criteria and, if the criteria are not satisfied, transmits a request to the autoregressive generator for an updated or modified set of keypoints 201, 202.

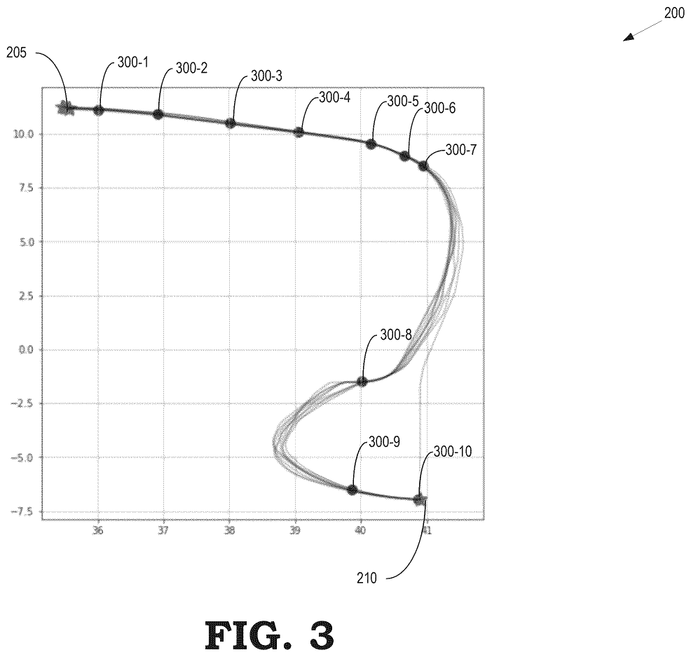

FIG. 3 illustrates keypoints 300 that are selected by the autoregressive generator based on a binning criterion that spreads the keypoints 300 along the trajectory of the non-human agent according to some embodiments. The autoregressive generator has selected ten keypoints 300-1 . . . 10, although other embodiments of the autoregressive generator can select more or fewer keypoints along the trajectory from the source location 205 to the destination location 210. As discussed herein, the autoregressive generator can select the keypoints 300 in response to a request from the keypoint scheduler to update or modify the selected keypoints 201, 202 to satisfy a binning criterion.

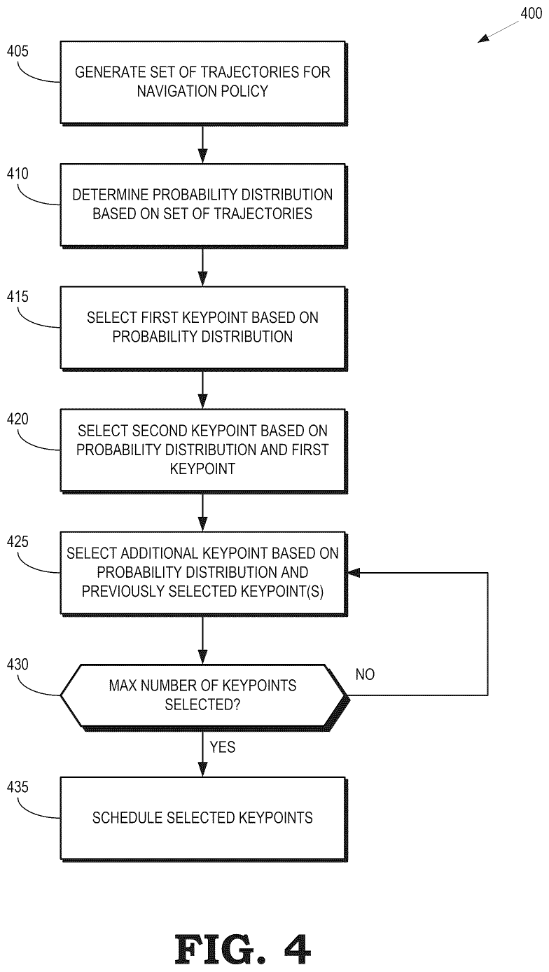

FIG. 4 illustrates a method 400 of selecting keypoints for motion of a non-human agent based on a probability distribution and previously selected keypoints between a source location and a destination location according to some embodiments. The method 400 is implemented in some embodiments of the processing system 100 shown in FIG. 1, e.g., using the autoregressive generator 118 and the keypoint scheduler 120.

At block 405, a set of trajectories between the source and destination locations is generated based upon a navigation policy for the non-human agent. As discussed herein, the navigation policy can be a policy to move in a human-like fashion, along a shortest path, and the like.

At block 410, a probability distribution is determined based on the set of trajectories. The probability distribution indicates probabilities that an instructive navigation agent passes by or through locations within the environment as the instructive navigation agents move from the source location to the destination location. The probability distribution indicates higher probabilities in regions where the density of trajectories from the set is higher and lower probabilities in regions where the density of trajectories from the set is lower.

At block 415, the autoregressive generator selects a (first) keypoint based on the probability distribution, as discussed herein. The first keypoint corresponds to a high likelihood, or a maximum likelihood, that the instructive navigation agent traverses the first location as it moves from the source location to the destination location.

At block 420, the autoregressive generator selects a second keypoint based on the probability distribution and the first keypoint, as discussed herein. The second keypoint corresponds to a high likelihood, or a maximum likelihood, that the instructive navigation agent traverses the second location as it moves from the source location to the destination location given that the instructive navigation agent first traverses the first location along its path.

At block 425, the autoregressive generator selects an additional keypoint based on the probability distribution and the previously selected keypoints. For example, if the autoregressive generator is selecting the third keypoint, the selection is made based on the probability distribution and the previously selected first and second keypoints. If the autoregressive generator is selecting the fourth keypoint, the selection is made based on the probability distribution and the previously selected first, second, and third keypoints. Thus, if the autoregressive generator is selecting the Nth keypoint, the selection is made based upon the probability distribution and the previously selected 1 . . . (N−1) keypoints.

At decision block 430, the autoregressive generator determines whether the maximum number of keypoints has been selected. If so, the method 400 flows to the block 435. If the maximum number of keypoints has not yet been selected, the method 400 flows to the block 425 and an additional keypoint is selected.

At decision block 435, the keypoints selected by the autoregressive generator are scheduled, e.g., by a keypoint scheduler. In some embodiments, the keypoint scheduler can determine whether the keypoints provided by the autoregressive generator satisfy a binning criteria. If not, the keypoint scheduler can request that the autoregressive generator selects a new or modified set of keypoints that satisfy the binning criteria. In other embodiments, the autoregressive generator accounts for the binning criteria during the selection process.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An apparatus comprising:
at least one memory configured to store information representing a distribution of probabilities that a first agent passes through locations in an environment as the first agent moves from a first location to a second location; and
at least one processor coupled to the memory and configured to:
select a first keypoint in an environment based on the distribution of probabilities;
select at least one second keypoint in the environment based on the distribution of probabilities and the first keypoint; and
instruct a second agent to move from the first location to the second location along a trajectory comprising the first keypoint and the at least one second keypoint.

2. The apparatus of 1, wherein the at least one processor is configured to:
iteratively select a plurality of second keypoints based on the distribution of probabilities, the first keypoint, and second keypoints selected in previous iterations of keypoint selection; and
instruct the second agent to move from the first location to the second location along the trajectory comprising the first keypoint and the plurality of second keypoints.

3. The apparatus of claim 1, wherein the at least one processor is further configured to:
generate the distribution of probabilities based on a set of navigation trajectories from the first location to the second location in the environment that are defined based on a navigation policy.

4. The apparatus of claim 1, wherein the at least one processor is configured to select the first keypoint based on a first optimization criterion for selecting a first coordinate that has a maximum likelihood of being a part of the trajectory from the first location to the second location.

5. The apparatus of claim 4, wherein the at least one processor is configured to select the at least one second keypoint based on at least one second optimization criterion for selecting at least one second coordinate that has a maximum likelihood of being a part of the trajectory from the first location to the second location given that the trajectory includes the first keypoint and any previously selected keypoints.

6. The apparatus of claim 1, wherein instructing the second agent to move from the first location to the second location along the trajectory comprises instructing the second agent to move through the first keypoint and second keypoint in a specified order.

7. The apparatus of claim 6, wherein the at least one processor is configured to tag the first keypoint and the at least one second keypoint with estimated arrival times for the second agent at the first keypoint and the at least one second keypoint, and wherein the specified order is based on the estimated arrival times.

8. The apparatus of claim 1, further comprising:
at least one gaming engine configured to implement a virtual environment, and wherein the at least one processor is configured to instruct a virtual non-human agent to move along the trajectory in the virtual environment.

9. The apparatus of claim 1:
wherein the environment is a physical environment; and
wherein the at least one processor is configured to instruct a physical non-human agent to move along the trajectory in the physical environment.

10. A method comprising:
selecting a first keypoint in an environment based on a distribution of probabilities that a first agent passes through locations in the environment as the first agent moves from a first location to a second location;
selecting at least one second keypoint in the environment based on the distribution of probabilities and the first keypoint; and
instructing a second agent to move from the first location to the second location along a trajectory comprising the first keypoint and the at least one second keypoint.

11. The method of claim 10:
wherein selecting the at least one second keypoint comprises iteratively selecting a plurality of second keypoints based on the distribution of probabilities, the first keypoint, and second keypoints selected in previous iterations of keypoint selection; and
wherein instructing the second agent comprises instructing the second agent to move from the first location to the second location along the trajectory comprising the first keypoint and the plurality of second keypoints.

12. The method of claim 10, further comprising:
generating the distribution of probabilities based on a set of navigation trajectories from the first location to the second location in the environment that are defined based on a navigation policy.

13. The method of claim 10, wherein selecting the first keypoint comprises selecting the first keypoint based on a first optimization criterion for selecting a first coordinate that has a maximum likelihood of being a part of the trajectory from the first location to the second location.

14. The method of claim 13, wherein selecting the at least one second keypoint comprises selecting the at least one second keypoint based on at least one second optimization criterion for selecting at least one second coordinate that has a maximum likelihood of being a part of the trajectory from the first location to the second location given that the trajectory includes the first keypoint and any previously selected keypoints.

15. The method of claim 10, further comprising:
wherein instructing the second agent to move from the first location to the second location along the trajectory comprises instructing the second agent to move through the first keypoint and second keypoint in a specified order.

16. The method of claim 15, further comprising:
tagging the first keypoint and the at least one second keypoint with estimated arrival times for the first agent at the first keypoint and the at least one second keypoint, and wherein the specified order is based on the estimated arrival times.

17. The method of claim 10, wherein instructing the second agent to move from the first location to the second location along the trajectory comprises instructing a virtual non-human agent to move along the trajectory in a virtual environment.

18. The method of claim 10, wherein the environment is a physical environment, and wherein instructing the second agent to move from the first location to the second location along the trajectory comprises instructing a physical non-human agent to move along the trajectory in the physical environment.

19. An apparatus comprising:
autoregressive generator circuitry configured to select a plurality of keypoints in an environment based on a distribution of probabilities that a first agent passes through locations in the environment as the first agent moves from a first location to a second location, wherein the autoregressive generator circuitry selects one of the plurality of keypoints per iteration, and wherein a keypoint is selected in an iteration based on the distribution of probabilities and keypoints selected in previous iterations; and
keypoint scheduler circuitry configured to order the plurality of keypoints in an order that plurality of keypoints is passed by the first agent moving along the trajectory from the first location to the second location.

20. The apparatus of claim 19, further comprising:
at least one gaming engine configured to implement a virtual environment or a physical environment, and wherein the autoregressive generator circuitry is configured to perform at least one of instructing a virtual non-human agent to move along the trajectory in the virtual environment in the order determined by the keypoint scheduler circuitry and instructing a physical non-human agent to move along the trajectory in the physical environment in the order determined by the keypoint scheduler circuitry.
